(19) United States
(12) Patent Application Publication
(10) Pub. No.: US 2013/0231865 A1
(43) Pub. Date: Sep. 5, 2013

(54) Method and System for Calculating and Presenting Options for Planning Transportation

(71) Applicants: Amrinder Arora, Centreville, VA (US); Nitin Sehra, Delni (IN)

(72) Inventors: Amrinder Arora, Centreville, VA (US); Nitin Sehra, Delni (IN)

(21) Appl. No.: 13/411,578

(22) Filed: Mar. 4, 2012

(51) Int. Cl. G06F 3/048; G01C 21/00

(52) U.S. Cl. 701/538; 715/810

(57) ABSTRACT

We present a new method and system to calculate and present options when planning to move or transfer from point A to point B. We are introducing a new concept where user have more defining measurable factors in route selection, with option to further optimize the result based on user preference. The method can be used for passenger trip planning (for example, when booking a flight) and for freight trip planning (for example, when shipping an object). Other examples and methods are also given.

### BACKGROUND

We present a new way to calculate and present routing options when you are travelling from point A to point B, or moving objects between 2 locations. The main problem that the travelers currently face when selecting trip options is that there is no holistic way to evaluate all aspects of an option. We elucidate this problem using some examples. For example, it is possible that the cheapest trip option takes about 3 times as long as an option that only costs a small fraction more. Similarly, the shortest possible option may cost 10 times as much as another option that takes fractionally longer time. Also, it is possible that an option that is shortest in time, as well as cheapest, uses an airline that has very low customer satisfaction. As another example, when shipping a container between two cities, it is possible that the cheapest and the fastest service is provided by a trucking company that has the largest (worst) environmental impact. The user generally would like a way to consolidate all options of a transportation option (whether for passenger travel or for freight transportation), in order to make a choice that performs reasonably well on multiple aspects.

### SUMMARY

We present a new method and system to calculate and present options when planning a trip from point A to point B. We are introducing a new concept where user have more defining measurable factors in route selection, with option to further optimize the result based on user preference. The method can be used for passenger trip planning (for example, when booking a flight) and for freight trip planning (for example, when shipping an object).

The method consists of 4 phases. First, we consider all attributes of each option. Second, we remove all options for which some attributes do not perform within lower and upper bounds. Third, we run a multi-criteria optimization to order the options. Finally, the system presents the options to the user. The user can then select any of the options. If needed, the user can also modify the configuration options and restart the process. See FIG. 1 for the process.

### BRIEF DESCRIPTION OF THE DRAWINGS

FIG. 1 shows an embodiment of the process.

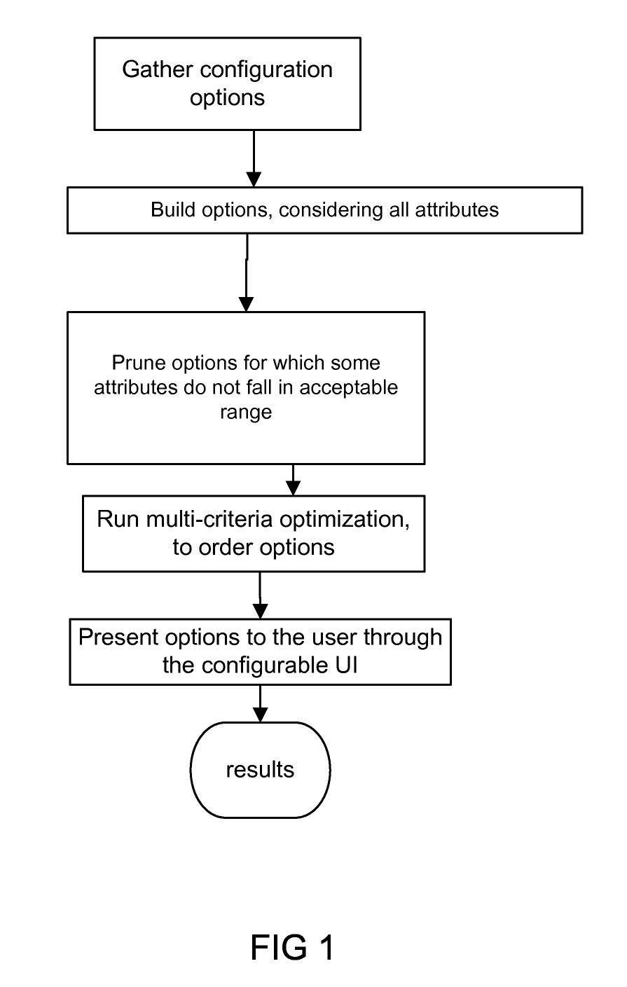

FIG. 2 shows an embodiment of an interface.

FIG. 3 shows an embodiment of the system.

FIG. 4 shows an embodiment of the system.

FIG. 5 shows an embodiment of the system.

FIG. 6 shows an embodiment of the system.

FIG. 7 shows an embodiment of an interface.

### DETAILED DESCRIPTION OF THE EMBODIMENTS

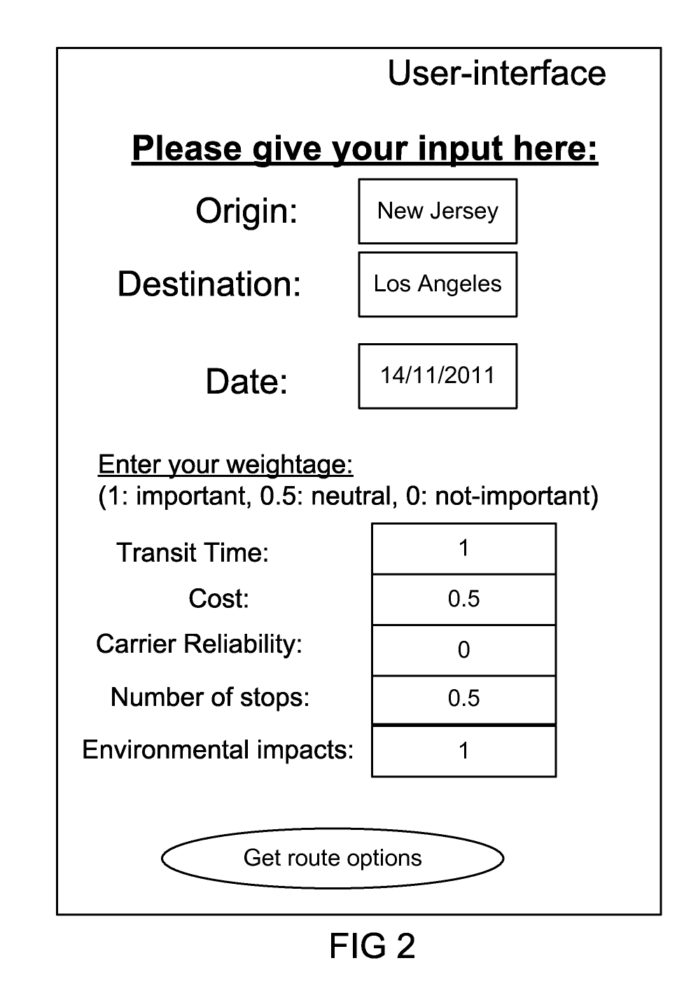

Gathering configuration options: In this setup phase, the system gathers some configuration options from the user, including the lower and upper bounds for all attributes, and the options for aggregate objective function. See FIG. 2 for an embodiment of an interface.

Considering all aspects of an option: As a first step, we expand the number of aspects that can be quantified and compared. Commonly use parameters in a traditional design are transit time and cost. Additionally, we also consider other options, such as the number of intermediate stops, quality of those intermediate stops, carrier reliability, carrier customer satisfaction rating, environmental impact, and the like. Based on the specific situation, any specific aspect that has a quantifiable score attached to it can be included as an aspect of an option. An example list of options with 5 attributes (transit time, cost, stops, environmental impact, and carrier reliability) is shown below. It brings multiple dimensions to the selection process.

TABLE 1
It shows the list of options with multiple attributes
(e.g. the origin is New Jersey, the destination is Los
Angeles, and the departure date is Nov. 14, 2011).

| Op- | | | | | Environmental | Carrier |
|---|---|---|---|---|---|---|
| tion | | Transit | Cost | No. of | Impact (CO2 | reli- |
| No. | carrier | Time | $ | stops | Emission) | ability |
| 01 | AA | 4 hrs | 170 | 0 | 10 | 81 |
| 02 | Delta | 4 hrs 15 min | 165 | 0 | 12 | 90 |
| 03 | United | 4 hrs 30 min | 168 | 0 | 13 | 85 |
| 04 | AA | 5 hrs 30 min | 150 | 1 | 30 | 81 |
| 05 | Jet | 7 hrs 30 min | 120 | 1 | 50 | 75 |
| | Blue | | | | | |
| 06 | Various | 7 hrs 45 min | 110 | 1 | 40 | NA |
| 07 | South | 9 hrs | 90 | 1 | 20 | 60 |
| | West | | | | | |
| 08 | Delta | 12 hrs | 80 | 3 | 60 | 90 |

Multiple Criteria Optimization: Multiple criteria optimization is the process of simultaneously optimizing two or more conflicting objectives subject to certain constraints. Multi criteria optimization problems can be found in various fields: product and process design, finance, aircraft design, the oil and gas industry, automobile design, or wherever optimal decisions need to be taken in the presence of trade-offs between two or more conflicting objectives.

In mathematical terms, the multi criteria problem can generally be written as:

Minₓ[μ₁(x),μ₂(x), . . . μₙ(x)]^{T}

Such that:

g(x)≦0

h(x)=0

x₁≦x≦xᵤ

wherein μᵢ is the i-th objective function, g and h are the inequality and equality constraints, respectively, and x is the vector of optimization or decision variables, with x₁ and xᵤ denoting the limits.

Aggregate objective function: One method for finding a solution to a multi criteria optimization problem is constructing a single aggregate objective function (AOF). The basic idea is to combine all of the objectives into a single objective function, called the AOF, such as weighted linear sum of the objectives. This objective function is optimized, subject to technological constraints specifying how much of one objective must be sacrificed, from any given starting point, in order to gain a certain amount regarding the other objective. One can use a matrix, such as 2×2 matrix, for the presentation.

Linear programming: It is a mathematical method for determining a way to achieve the best outcome (such as maximum profit or lowest cost) in a given mathematical model for some list of requirements represented as linear relationships.

Canonical form: Linear programs problems can be expressed in canonical form, in this general form:

Maximize or Minimize C^{T}x

Subject to: Ax≦b and 0≦x

where x represents the vector of variables (to be determined), c and b are vectors of (known) coefficients, and A is a (known) matrix of coefficients. The expression to be maximized or minimized is called the objective function (C^{T}x in this case). The equations of type (Ax≦b) are the constraints which specify a convex polytope (in N-dimension) over which the objective function is to be optimized.

For example, one may want to choose flights of less than 8 hours, plus price of less than 300 US$.

Standard Form: Standard form is a form of describing a linear programming problem. It consists of the following four parts:
A linear function to be maximized, e.g.:
   Max_{x1, x2} f (x₁, x₂)=c₁ x₁+c₂ x₂
Problem constraints of the following form, e.g.:
   a₁₁ x₁+a₁₂ x₂≦b₁
   a₂₁ x₁+a₂₂ x₂≦b₂
   a₃₁ x₁+a₃₂ x₂≦b₃
Non-negative variables, e.g.:
   0≦x₁
   0≦x₂
Non-negative right-hand side constants:
   0≦bᵢ, for i=1, 2, 3, . . . .

The problem is usually expressed in matrix form, and then becomes:

Max{C^{T}x/(0≦Ax≦b)̂(0≦x)}

Other forms, such as minimization problems, problems with constraints on alternative forms, as well as problems involving negative variables, can always be rewritten into an equivalent problem in the standard form.

The following algorithms can be used: Simplex algorithm of Dantzig, Criss-cross algorithm, Ellipsoid algorithm, Projective algorithm of Karmarkar, or Path-following algorithms.

In the following, we show more aspects of a user planning a trip from New Jersey to Los Angeles. With each aspect having measurable value attached to it, this new representation of routing option would help user to have a broader view on available options.

Removal of Options that do not meet some bounds: In this phase, all options for which some attributes do not meet some bounds are removed. For example, it may be that the passenger does not wish to travel on a flight that has more than 3 intermediate stops, or that the business does not want to use any trucking company that has a total environmental impact greater than a preselected value.

An example algorithm listing that achieves this phase is as follows:

For O in List of Options:

For A in List of Attributes:

if [ (O.A < preselectedLowerBound(A) ) or
( O.A > preselecedUpperBound (A) ) ]

Then: Remove O from List of Options &
proceed to the next option

In route option with different aspects, there is a possibility of conflicting attributes. For example, keeping the cost low, as well as transit time low, with no late departures, requires multiple criteria optimization. Similarly, keeping intermediate stops low or zero and cost low requires multiple criteria optimization.

In one embodiment, we do not use linear programming, because Aggregate Objective Functions can use non-linear equations, as well. In that respect, linear programming (LP) formulation is a special case of Aggregate Objective Functions (AOF). LP formulations can typically be solved faster, but they do not provide adequate flexibility in terms of options.

User Interface Options for Configuring Multi-Criteria Optimization: Tables 2-3 show an example form where user provides information about the origin, destination and date of travel. Also, user specifies its preferences (weightage) for the aspects, such as transit time, cost, carrier reliability, intermediate stops, and the like. User can specify which aspect is important, not-important, or neutral. In the example, user specifies transit time and environmental impact as important, cost and intermediate stops as neutral, and carrier reliability as not-important.

Presenting of Options to the User: Tables 2-3 display the routing option, showing different aspects. The Rank Index column shows the rank of each particular route option, considering user specified options for the aggregate objective function. The user interface lists the options in the descending order of that aggregate objective function. (See Tables 2-3.)

TABLE 2
It shows the list of options (e.g. the origin is New Jersey, the destination is Los Angeles,
and the departure date is Nov. 14, 2011), with the highlighted and selected areas.

| | | | | | Environmental | | |
|---|---|---|---|---|---|---|---|
| Option | | Transit | Cost | No. of | Impact (CO2 | Carrier | Rank |
| No. | carrier | Time | $ | stops | Emission) | reliability | Index |
| 01 | AA | 4 hrs | 170 | 0 | 10 | 81 | 5 ¶ ✓ |
| 02 | Delta | 4 hrs 15 min | 165 | 0 | 12 | 90 | 5.5 ¶ |
| 03 | United | 4 hrs 30 min | 168 | 0 | 13 | 85 | 5.5 ¶ |
| 04 | AA | 5 hrs 30 min | 150 | 1 | 30 | 81 | . . . |
| 05 | Jet Blue | 7 hrs 30 min | 120 | 1 | 50 | 75 | . . . |
| 06 | Various | 7 hrs 45 min | 110 | 1 | 40 | NA | . . . |
| 07 | South West | 9 hrs | 90 | 1 | 20 | 60 | . . . |
| 08 | Delta | 12 hrs | 80 | 3 | 60 | 90 | 13 ¶ |

As shown in Table 2, the first row is check-marked, and the 3^{rd} row is highlighted, as shown in Table 3, below, as the Appendix to Table 2, e.g. Table 3 being overlapped on Table 2, on screen of the computer, for the user interface (GUI), originating from the last (on the right side) column of the 3^{rd} row, from the symbol ¶ shown on the table.

Table 3. It shows the pop-up menu or window coming out of Table 2, overlapping Table 2, on computer screen, as described above, as an example, for criteria, with weightage and rating:

| Criteria | Weightage | Rating |
|---|---|---|
| Journey Time | 1 | 2 |
| Cost Compare | 0.5 | 4 |
| Intermediate | 0.5 | 1 |
| stops | | |
| Stop delay | 1 | 1 |
| risk | | |
| Carrier | 0 | 2 |
| reliability | | |

Please note that, in one embodiment, we have (for the Table 3, above):

Rank index=Σ(weightage X rating)

The comparison for cost can be done using absolute values or relative values, e.g. the lowest number in the table, as 80 US$, as the baseline. An average number can also be used as the baseline. Then, the ratio of the cost values is multiplied to weight, for comparison purposes, for other possibilities, to find the optimum choice(s).

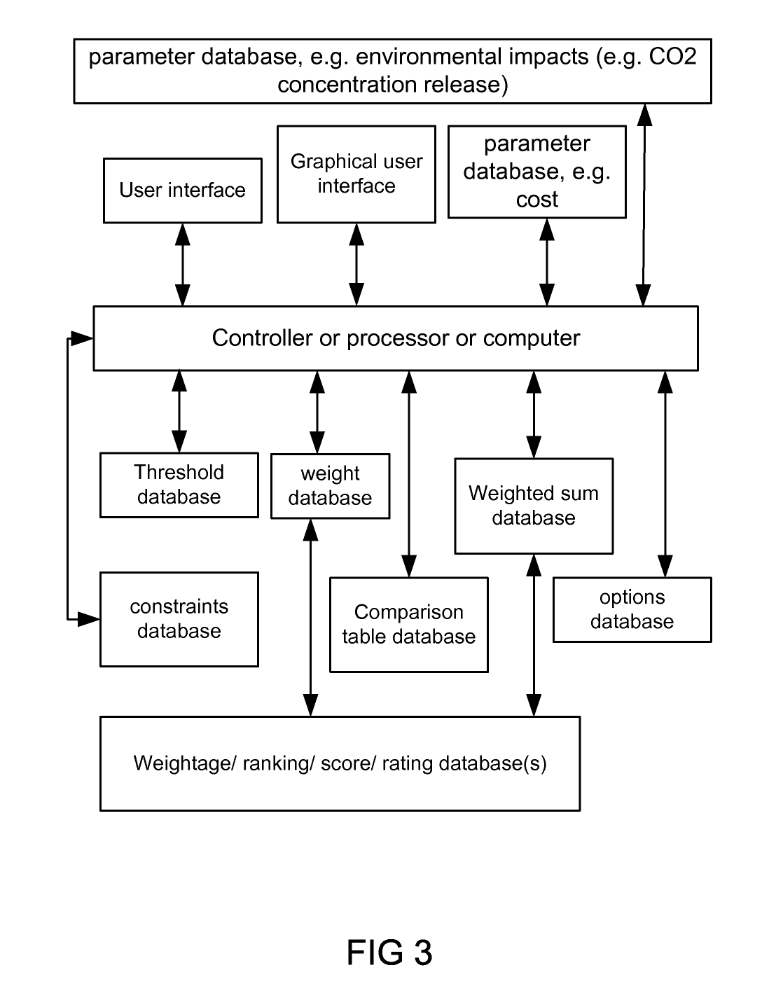

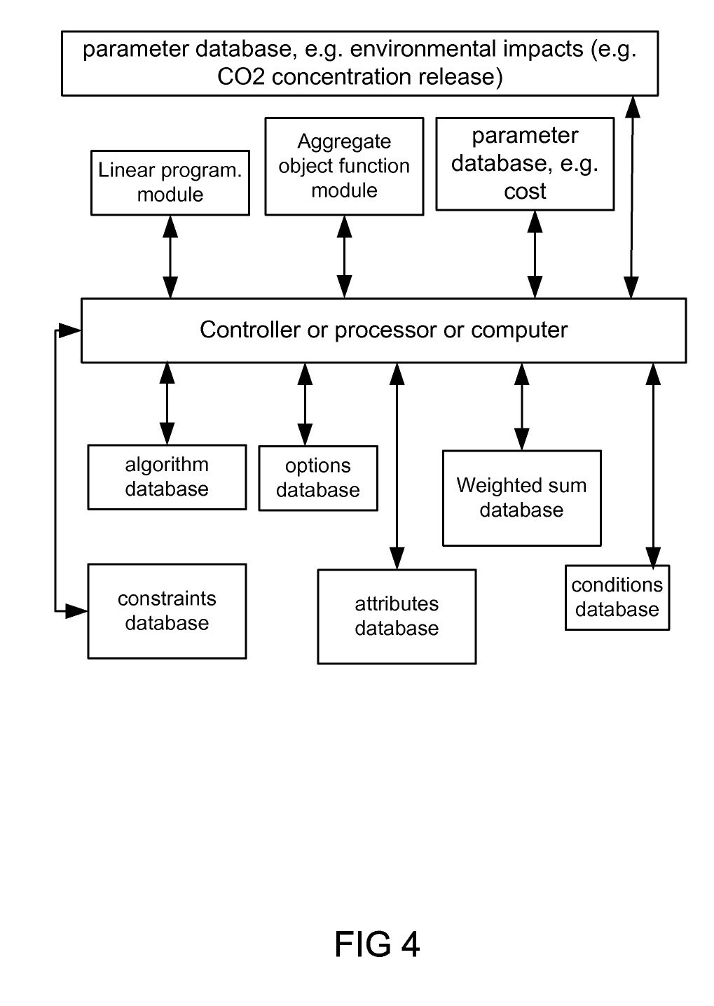

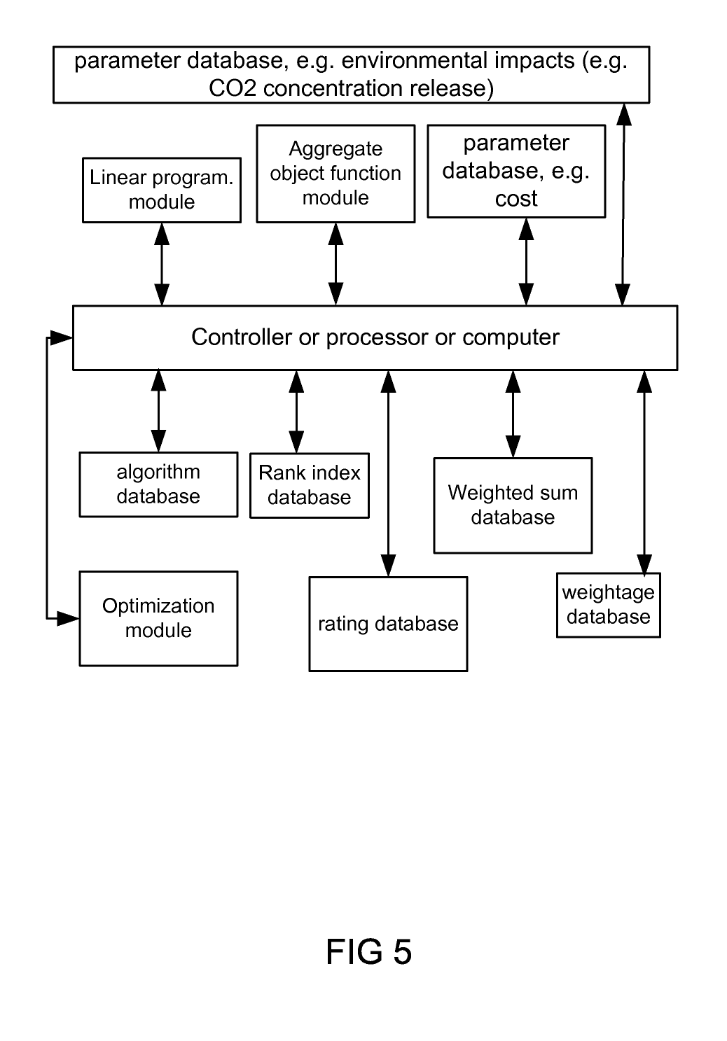

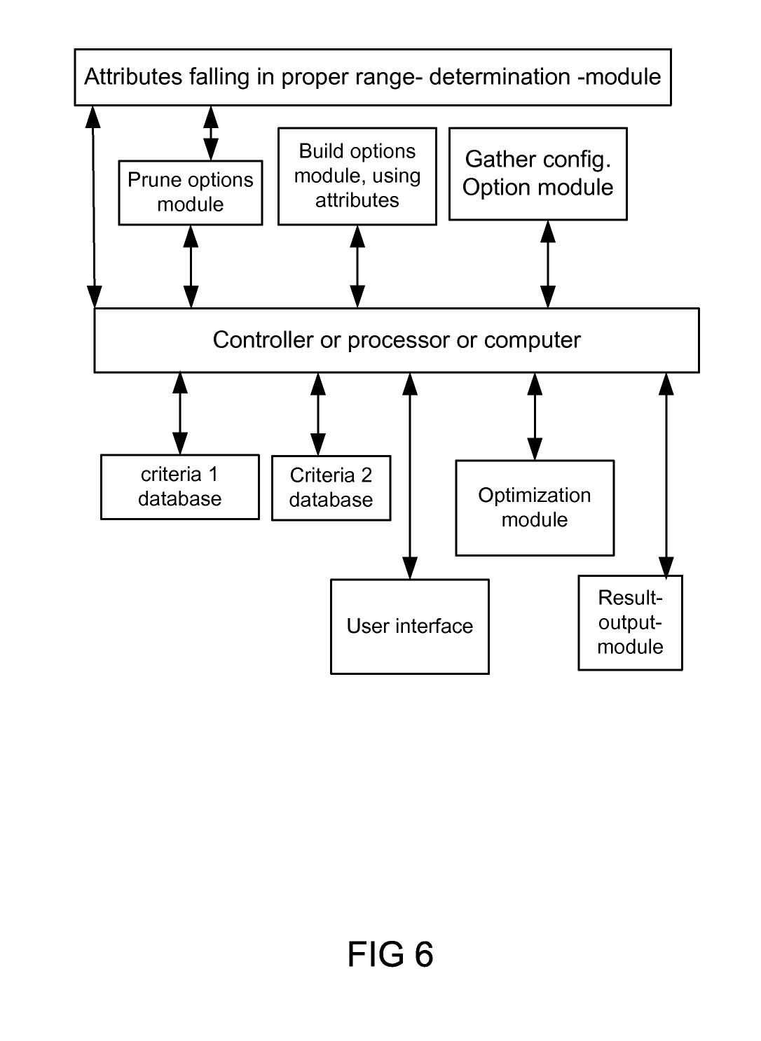

FIG. 3-6 show multiple systems for embodiments of this invention, with various components.

In one embodiment, our system has a central processing unit, along with multiple storage units, with some user input interface/unit, and communication units between processing module and other modules. The data or parameters are stored in memory units, storages, databases, tables, lists, spreadsheets, physical devices or modules or units, or the like. The comparisons and calculations are done by a system, processor, computer, server, computing device, or microprocessor. The modules are connected through buffers or other memory units, with another processor directing all the data transfer and actions, as one embodiment. One can combine processors and memory units, in one or fewer units, if desired, in another embodiment.

In one embodiment, we have a method for calculating and presenting options to a user for planning a trip or transportation, with the following steps: an aggregation module gathering configuration options; a construction module receiving all attributes; the construction module building options, using said all attributes; an evaluator module determining one or more attributes that do not satisfy one or more predetermined conditions; and for those one or more attributes, pruning corresponding options; running multi-criteria optimization; ordering remaining options; and a user interface module presenting options to a user.

In one embodiment, we have one or more of the following the steps for the process: choosing an algorithm, ranking entries, calculating weighted average or weighted sum, applying linear programming, applying aggregate function, applying constraints or conditions, applying thresholds, inequality relationships, or equality relationships, presenting an optimum route for shipping, presenting an optimum route for traveling, classifying weightage as a percentage number, classifying weightage as a real number between 0 and 1, highlighting entries on tables on computer screen, selecting entries on tables on computer screen, displaying popup menus or windows on computer screen, calculating rank index, using weightage and rating values, and normalizing values in a table, using a minimum value, an average value, or a median value.

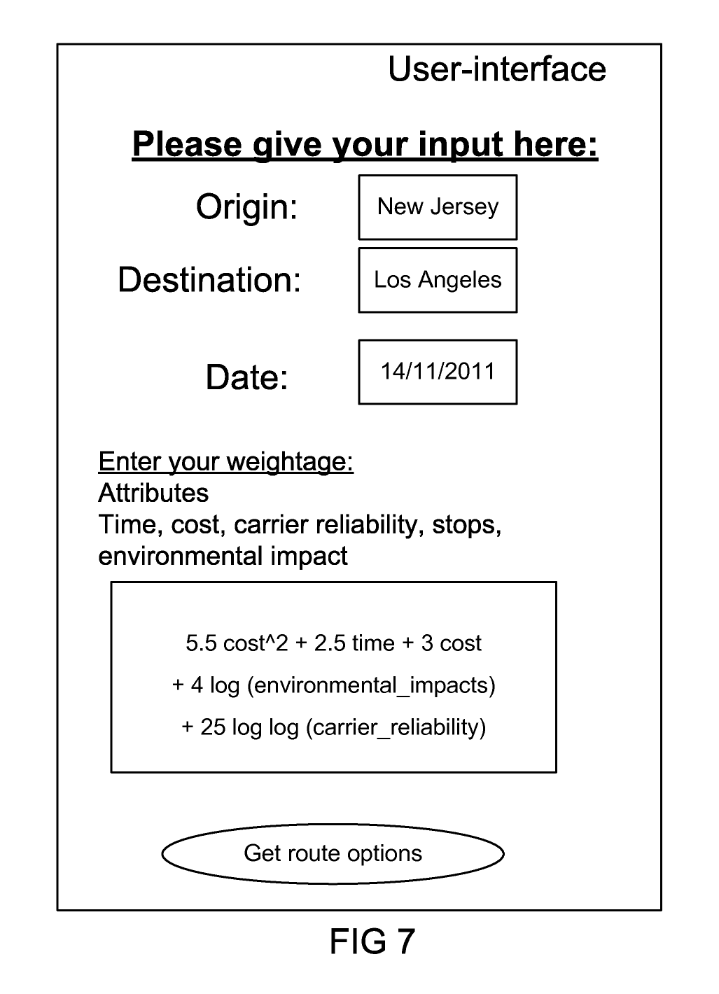

In one embodiment, as shown in FIG. 7, the Aggregate Objective Function (AOF) can be more general than the linear optimization. For example, it can include polynomial terms, logarithmic, and polylog terms. FIG. 7 shows an embodiment of an interface.

Another variation of Table 2 is given below in Table 4, as one embodiment.

Table 4. It shows the list of options (e.g. the origin is New Jersey, the destination is Los Angeles, and the departure date is Nov. 14, 2011), with the highlighted and selected areas.

| | | | | | Environmental | | |
|---|---|---|---|---|---|---|---|
| Option | | Transit | Cost | No. of | Impact (CO2 | Carrier | Rank |
| No. | carrier | Time | $ | stops | Emission) | reliability | Index |
| 01 | AA | 4 hrs | 170 | 0 | 10 | 81 | 5 ¶ ✓ |
| 02 | Delta | 4 hrs 15 min | 165 | 0 | 12 | 90 | 5.5 ¶ |
| 03 | United | 4 hrs 30 min | 168 | 0 | 13 | 85 | 5.5 ¶ |
| 04 | AA | 5 hrs 30 min | 150 | 1 | 30 | . . . | . . . |
| 05 | Jet Blue | 7 hrs 30 min | 120 | 1 | 50 | . . . | . . . |
| 06 | Various | 7 hrs 45 min | 110 | 1 | 40 | NA | 10.5 ¶ |
| 07 | South West | 9 hrs | 90 | 1 | 20 | 60 | 9 ¶ |
| 08 | Delta | 12 hrs | 80 | 3 | 60 | 90 | 13 ¶ |

As shown in Table 4, the first row is check-marked, and the 3^{rd} row is highlighted, with a pop-up menu or window appearing, as the Appendix to Table 4, e.g. Table 4 being overlapped or covered by the pop-up menu or window, on screen of the computer, for the user interface (GUI), originating from the last (on the right side) column of the 3^{rd} row, from the symbol ¶ shown on the table.

The pop-up menu or window shows the phrase (as an example): “Based on Aggregate Objective Function (AOF)”, overlapping Table 4, on the computer screen, as described above, as an example, for any information needed for the user.

Any variations of the above teaching are also intended to be covered by this patent application.

1. A method for calculating and presenting options to a user for planning a trip or transportation, said method comprising:
an aggregation module gathering configuration options;
a construction module receiving all attributes;
said construction module building options, using said all attributes;
an evaluator module determining one or more attributes that do not satisfy one or more predetermined conditions;
for said one or more attributes, pruning corresponding options;
running multi-criteria optimization;
ordering remaining options; and
a user interface module presenting options to a user.

2. The method for calculating and presenting options to a user for planning a trip or transportation as recited in claim 1, said method comprising:
a user inputting origin of trip or transportation, destination of trip or transportation, or date of trip or transportation.

3. The method for calculating and presenting options to a user for planning a trip or transportation as recited in claim 1, said method comprising:
a user inputting weightage, weight, score, or rating.

4. The method for calculating and presenting options to a user for planning a trip or transportation as recited in claim 1, said method comprising:
choosing an algorithm.

5. The method for calculating and presenting options to a user for planning a trip or transportation as recited in claim 1, said method comprising:
ranking entries.

6. The method for calculating and presenting options to a user for planning a trip or transportation as recited in claim 1, said method comprising:
calculating weighted average or weighted sum.

7. The method for calculating and presenting options to a user for planning a trip or transportation as recited in claim 1, said method comprising:
applying linear programming.

8. The method for calculating and presenting options to a user for planning a trip or transportation as recited in claim 1, said method comprising:
applying aggregate function.

9. The method for calculating and presenting options to a user for planning a trip or transportation as recited in claim 1, said method comprising:
applying constraints or conditions.

10. The method for calculating and presenting options to a user for planning a trip or transportation as recited in claim 1, said method comprising:
applying thresholds, inequality relationships, or equality relationships.

11. The method for calculating and presenting options to a user for planning a trip or transportation as recited in claim 1, said method comprising: presenting an optimum route for shipping.

12. The method for calculating and presenting options to a user for planning a trip or transportation as recited in claim 1, said method comprising:
presenting an optimum route for traveling.

13. The method for calculating and presenting options to a user for planning a trip or transportation as recited in claim 1, said method comprising:
classifying weightage as important, neutral, or not-important.

14. The method for calculating and presenting options to a user for planning a trip or transportation as recited in claim 1, said method comprising:
classifying weightage as a percentage number.

15. The method for calculating and presenting options to a user for planning a trip or transportation as recited in claim 1, said method comprising:
classifying weightage as a real number between 0 and 1.

16. The method for calculating and presenting options to a user for planning a trip or transportation as recited in claim 1, said method comprising:
highlighting entries on tables on computer screen.

17. The method for calculating and presenting options to a user for planning a trip or transportation as recited in claim 1, said method comprising:
selecting entries on tables on computer screen.

18. The method for calculating and presenting options to a user for planning a trip or transportation as recited in claim 1, said method comprising:
displaying popup menus or windows on computer screen.

19. The method for calculating and presenting options to a user for planning a trip or transportation as recited in claim 1, said method comprising:
calculating rank index, using weightage and rating values.

20. The method for calculating and presenting options to a user for planning a trip or transportation as recited in claim 1, said method comprising:
normalizing values in a table, using a minimum value, an average value, or a median value.
